(19) United States
(12) Patent Application Publication
(10) Pub. No.: US 2019/0039289 A1
(43) Pub. Date: Feb. 7, 2019

(54) MANUFACTURE AND USE OF ANNEALED POLYMER POWDERS SUITABLE FOR SELECTIVE LASER SINTERING

(71) Applicant: Depuy Synthes Products, Inc., Raynham, MA (US)

(72) Inventors: Jamie OWENS, Downingtown, PA (US); Kristin KITA, West Chester, PA (US); Roderick MCMILAN, West Chester, PA (US)

(21) Appl. No.: 16/049,455

(22) Filed: Jul. 30, 2018

Related U.S. Application Data
(60) Provisional application No. 62/539,615, filed on Aug. 1, 2017.

(51) Int. Cl. B29C 64/153; B29C 67/04; B29C 35/08

(52) U.S. Cl. CPC B29C 64/153; B33Y 10/00; B29C 35/0805; B29C 67/04

(57) ABSTRACT

A three-dimensional object may be produced with improved dimensional control by laser sintering a polymer powder having a melting point and melting onset temperature, which has been annealed prior to sintering. The initial melting onset temperature of the polymer is between 50° C. and 170° C. The polymer powder is first annealed at a temperature which is below the polymer melting point, and from 5° C. above the melting onset temperature of the polymer powder to 10° C. below the melting onset temperature. Annealing may be carried out for a period of between 2 hours and 48 hours. A layer of the annealed polymer powder is applied to a carrier; and the layer is irradiated with a laser beam in areas of the layer which correspond to the three-dimensional object to be produced. The steps of applying the annealed polymer powder and irradiating the powder are repeated sequentially until the complete three-dimensional object is prepared. The irradiating step sinters the annealed polymer powder in areas of the layer which correspond to the three-dimensional object, without sintering the annealed polymer powder in other areas.

### TECHNICAL FIELD

The current application is directed to polymer powders useful in 3D printing, where the polymer powders have improved thermal properties and increased melting points, and methods of manufacturing articles by a process of selective laser sintering using such particles.

### BACKGROUND

Selective laser sintering (SLS) of polymer powders is becoming an increasingly important method of manufacturing porous articles, including implantable medical articles with pores suitable for tissue ingrowth. However, the range of polymers commonly used for SLS is restricted. Polyamide 11 and polyamide 12 (melting point: 178-187° C.) have been used with some success, as well as a few exotic polymers. These exotic polymers include polyetherketone polymers, thermoplastic urethane polymers, and polyether polyamide block copolymers. Attempts have been made to identify alternative polymers for SLS. Polybutylene terephthalate was found to exhibit warpage and cracking in SLS processes, and is high melting (melting point ˜223° C.). Polyoxymethylene also exhibited significant warpage on SLS processing. Some success was obtained with polyethylene and polypropylene powders; however, these materials are not biodegradable. There is a need in the art for biodegradable and bioresorbable polymer powders which may be fabricated into dimensionally accurate medical articles by SLS, without cracking or warping.

Poly(caprolactone) is a low-melting bioresorbable polymer which has been used in manufacturing articles by selective laser sintering. However, the smallest pores in articles fabricated by laser sintering are typically 1.75 mm (1,750 microns). Particles near boundaries of designed features, but outside these boundaries, are prone to sintering within scaffold pores, causing dimensional inaccuracy and reduced pore volume. When scaffolds are printed from a 3D design by laser sintering, the porosity of the finished article is 30% to 40% lower than the intended porosity of the article as designed, due to sintering of excess poly(caprolactone).

Low-melting polymer powders, i.e., powders with a melting onset temperature of between 50° C. and 170° C., which are resistant to particle agglomeration during sintering, are suitable for selective laser sintering in the manufacture of 3D articles by selective laser sintering. Such powders may include olefin polymers, polylactones, polylactides, and acetal polymers.

Improved biocompatible and/or bioresorbable polymer powders, i.e., polylactones and polylactides, are of particular interest, as they would be particularly suitable for preparation of implantable medical devises by selective laser sintering with high accuracy.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of an exemplary embodiment adequate to allow those of ordinary skill in the art to make and use the inventive concepts will follow in later sections.

Various embodiments disclosed herein relate to a method for producing a three-dimensional object by laser sintering. In some embodiments, the method involves annealing a polymer powder having a melting onset temperature of between 50° C. and 170° C., where the annealing is carried out at a temperature which is:
from below the melting point Tm of the polymer to 6° C. below the melting onset temperature;
from 3° C. above the melting onset temperature to 5° C. below the melting onset temperature;
from 2° C. above the melting onset temperature to 5° C. below the melting onset temperature; or
from 0° C. below the melting onset temperature to 5° C. below the melting onset temperature.

In some embodiments, the annealing step may be carried out for a period of between 2 hours and 48 hours. However, there is no particular minimum on the amount of time annealing may be carried. In principle, particles may be stored at an elevated temperature at or near the melting onset temperature, e.g., below the melting point but within 5° C., 3° C., or 2° C. of the melting onset temperature, for an extended period of time, e.g., greater than 48 hours. Alternatively, particles may be annealed for less than two hours, e.g., from five minutes to two hours, from 10 minutes to two hours, from thirty minutes to two hours, or from one to two hours, if desired; the lower limit on annealing time is defined only by the period of time required to heat the particles evenly throughout.

After annealing, a first layer of the annealed polymer powder is applied to a carrier; and the layer is irradiated with a laser beam in areas of the layer which correspond to a cross-section of the three-dimensional object to be produced. Following irradiation of the first layer, a second layer of the annealed polymer powder is deposited on the first layer; and the second layer is irradiated with the laser beam in areas of the layer which correspond to a second cross-section of the three-dimensional object. This process is continued until the three three-dimensional object is completed. Each irradiating step sinters the annealed polymer powder in areas which correspond to the desired cross-section, without sintering the annealed polymer powder in areas outside the corresponding areas. In various embodiments, areas which correspond to the desired cross-section are defined by an edge, where sintering takes place in areas which lie inside the defined edge, but not in areas which lie outside the defined edge. The resulting may be a porous three-dimensional object, with an increased void volume and/or reduced pore occlusions, compared to a three-dimensional object produced from a portion of the polymer powder which has not been subjected to an annealing step.

In various embodiments, the polymer powder is a powder of a polymerized C4-C8 lactone; a polymer of an olefin selected from the group consisting of ethylene, propylene, n-butene, iso-butene, and a mixture thereof; or a polyvinyl acetal. The polymer powder may be poly(caprolactone); polyethylene; polypropylene; or a polyvinyl butyral. In some embodiments, the polymer powder is a poly(caprolactone) powder having an initial melting onset temperature of between 50° C. and 60° C. prior to annealing. When subjected to an annealing step, the annealing increases the initial melting onset temperature of the poly(caprolactone) powder to a final melting onset temperature which is between about 2° C. and about 10° C. higher than the initial melting onset temperature, between about 3.5° C. and about 10° C. higher than said initial melting onset temperature, or between about 5° C. and about 10° C. higher than said initial melting onset temperature.

In various embodiments disclosed herein, the annealing step is carried out by annealing a polymer powder having a melting onset temperature, where the annealing is carried out at a temperature which is from 0° C. to 10° C., from 0° C. to 5° C., from 1° C. to 5° C., from 2° C. to 4° C., or from 2° C. to 3° C. below the melting onset temperature of the polymer powder. In various embodiments disclosed herein, the annealing step is carried out by annealing a polymer powder having a melting point and a melting onset temperature, where annealing is carried out at temperatures which are below the melting point, and from 3° C. above to from 5° C. below the melting onset temperature The annealing is carried out for between 2 hours and 48 hours, 8 hours and 48 hours, 12 hours and 48 hours, 19 hours and 48 hours, or 24 hours and 48 hours.

In some embodiments disclosed herein, the annealing step is carried out by annealing a polymer powder having a melting onset temperature and a melting point, where the annealing is carried out at a temperature which is below the melting point, and also:
from 5° C. above the melting onset temperature of the polymer powder to 10° C. below the melting onset temperature,
from 3° C. above the melting onset temperature of the polymer powder to 8° C. below the melting onset temperature,
from 2° C. above the melting onset temperature of the polymer powder to 5° C. below the melting onset temperature, or
from 1° C. above the melting onset temperature of the polymer powder to 3° C. below the melting onset temperature.

In various embodiments, the polymer powder has a defined particle size range prior to the annealing step. If the polymer powder is sintered without an annealing step, where sintering is from 0° to 5° below the melting onset temperature, the powder may be subject to fusion and agglomeration to broaden the particle size range. If the polymer powder is annealed prior to sintering near its melting onset temperature, the powder is not subject to agglomeration and the particle size range is unchanged by sintering. In the case of an annealed polycaprolactone powder having a defined particle size range; the particle size range may be unchanged upon sintering the annealed polycaprolactone powder at a sintering temperature of between about 5° C. below the initial melting onset temperature, i.e., the polycaprolactone melting onset temperature prior to annealing, and about 5° C. above the initial melting onset temperature.

In various embodiments, the polymer powder may be prepared from a mixture of a higher melting powder and a lower melting powder, where the higher melting powder and the lower melting powder have similar monomer composition and molecular weight, but different crystallinity. In various embodiments, the polymer powder comprises a first polymer powder having a melting onset temperature T_{1,onset} of between >50° C. and 170° C., and a second polymer powder having a melting onset temperature T_{2,onset} of between 50° C. and <170° C., where T_{1,onset}>T_{2,onset}. If the first and second polymer powders are made from the same polymer and have the same molecular weight, an annealing step causes T_{1,onset} and T_{2,onset} to each increase so as to converge on a uniform melting onset temperature T_{3,onset}; or to reach a uniform melting temperature. The resulting polymer powder has a uniform crystallinity. The first polymer powder and the second polymer powder may be mixed to produce a mixed polymer powder, either before or after the annealing step.

In some embodiments, the mixture of polymer powders may include a first polymer powder having T_{1,onset} of between 50° C. and 170° C. and a first melting point T_{1,m}, and a second polymer powder having T_{2,onset} of between 50° C. and 170° C. and a second melting point T_{2,m}, where T_{1,m}>T_{2,m}. The first and second polymer powders are made from the same polymer and have the same molecular weight. In these conditions, annealing causes T_{1,m} and T_{2,m} to each increase and converge on a uniform melting onset temperature T_{3,m}; or to reach a uniform melting onset temperature. Again, the first polymer powder and the second polymer powder may be mixed to produce a mixed polymer powder, either before or after the annealing step. In various embodiments, annealing simultaneously causes:

T_{1,onset} and T_{2,onset} to converge on a uniform melting onset temperature T_{3,onset}; and

T_{1,m} and T_{2,m} to each converge on a uniform melting point T_{3,m}.

In various embodiments, the polymer powder is a polyester obtained by polycondensation of a C4-C8 lactone, a C3-C10 hydroxycarboxylic acid, or a mixture thereof; a polymer of an olefin selected from the group consisting of ethylene, propylene, n-butene, iso-butene, and a mixture thereof; or a polyvinyl acetal.

In various embodiments, the polymer powder is a polyester obtained by polycondensation of: a lactone selected from the group consisting of 3,6-dimethyl-1,4-dioxan-2,5-dione, trimethylene carbonate, trimethylene carbonate, an α-lactone, a β-lactone, a γ-lactone, a δ-lactone, a ε-lactone, and a mixture thereof; a hydroxy acid selected from the group consisting of an α-hydroxycarboxylic acid, a β-hydroxycarboxylic acid, a γ-hydroxycarboxylic acid, a δ-hydroxycarboxylic acid, and a mixture thereof, or a mixture of at least one of the lactones and at least one the hydroxyacids previously listed.

In various embodiments, the polymer powder is a polyester obtained by polycondensation of: a lactone selected from the group consisting of 6-valerolactone, ε-caprolactone, and a mixture thereof; and a comonomer selected from the group consisting of 3,6-dimethyl-1,4-dioxan-2,5-dione, trimethylene carbonate, an α-hydroxycarboxylic acid, and a mixture thereof.

In various embodiments, the polymer powder is a homopolyester obtained by polycondensation of ε-caprolactone; or a copolyester obtained by polycondensation of a) ε-caprolactone and b) 3,6-dimethyl-1,4-dioxan-2,5-dione, trimethylene carbonate, lactic acid, glycolic acid, or a mixture thereof.

### BRIEF DESCRIPTION OF THE DRAWINGS

In order to better understand various exemplary embodiments, reference is made to the accompanying drawings, wherein:

FIG. 1 shows DSC thermograms of two poly(caprolactone) powders with an initial melting temperature of 59.1° C. A poly(caprolactone) powder which has not been annealed has a melting temperature of 59.07° C. and a melting onset temperature of 54.15° C. A poly(caprolactone) powder which has been annealed for 24 hours at 55° C. has a melting temperature of 65.31° C. and a melting onset temperature of 60.56° C.

FIG. 2 shows the change in melting point of poly(caprolactone) powder with an initial melting temperature of 59.1° C. Melting point is recorded as a function of annealing time, where annealing is carried out at multiple temperatures ranging from 50° C. to 55° C. The legend in FIG. 2 shows annealing temperature in degrees C.

FIG. 3 shows the change in melting onset temperature of poly(caprolactone) powder with an initial melting temperature of 59.1° C. Melting onset temperature is recorded as a function of annealing time, where annealing is carried out at multiple temperatures ranging from 50° C. to 55° C. The legend in FIG. 3 shows annealing temperature in degrees C.

FIG. 4 shows particle size analysis of poly(caprolactone) powders with an initial melting temperature of 59.1° C., with and without a sintering treatment at 55° C. Each powder had a particle size range from 6 microns to 200 microns prior to sintering. Trace F represents the particle size distribution of a poly(caprolactone) powder which has not been annealed or sintered. A poly(caprolactone) powder which has not been annealed prior to sintering has a broadened particle size range after sintering, with a significant peak corresponding to a particle diameter of ˜500 microns (Trace C). A poly(caprolactone) powder which has been annealed for 24 hours at a temperature of between 52° C. and 55° C. showed no change in the particle size distribution after sintering (Trace G).

FIG. 5 shows the impact of annealing on the thermal properties of a polycaprolactone powder with an inherent viscosity of 1.2 dl/g, based on results presented in Table 3.

FIG. 6 shows DSC thermograms of five poly(caprolactone) powders with an initial melting temperature of 63° C. A poly(caprolactone) powder which has not been annealed has a melting temperature of 63° C. and a melting onset temperature of 52.8° C. Poly(caprolactone) powders which have been annealed for between 2 and 48 hours at 54° C. have a melting onset temperature of between 56° C. and 59° C., with a narrower melting range than the unannealed poly(caprolactone) powder.

FIG. 7 shows the change in melting onset temperature of poly(caprolactone) powder with an initial melting temperature of 63° C. Melting onset temperature is recorded as a function of annealing time, where annealing is carried out at multiple temperatures ranging from 50° C. to 55° C.

FIG. 8 shows a three-dimensional cage prepared by 3D printing with an unannealed poly(caprolactone) powder with a melting temperature of 63° C.

FIG. 9 shows a three-dimensional cage prepared by 3D printing with a poly(caprolactone) powder with a melting temperature of 63° C., which has been annealed prior to printing.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiment

“Melting point,” or Tₘ, as used in the present disclosure, refers to the temperature of maximum endothermic heat flow during a solid-to-liquid phase transition, as measured by differential scanning calorimetry (DSC).

“Melting onset temperature,” or Tₒₙₛₑₜ, as used in the present disclosure, refers to the temperature at which a solid-to-liquid phase transition begins, as measured by differential scanning calorimetry (DSC). Tₒₙₛₑₜ is determined as the intersection of a line which is tangent to the baseline of a DSC curve and a line which is tangent to an endothermic DSC peak, at a point where a rate of change of endothermic heat flow is maximum.

“Converge,” as used in the present disclosure, means that two values, e.g., two temperatures, approach a common value. The converging values may reach a common value, but are not required to reach a common value.

“Annealing,” as used in the present disclosure, refers to thermal treatment of a crystalline or semi-crystalline polymer to a temperature that is below the melting point (Tₘ) of the polymer, and also:
between about 10° C. below the melting onset temperature (Tₒₙₛₑₜ) of the polymer and about 5° C. above the Tₒₙₛₑₜ of the polymer,
between about 8° C. below Tₒₙₛₑₜ of the polymer and about 3° C. above Tₒₙₛₑₜ of the polymer,
between about 5° C. below Tₒₙₛₑₜ of the polymer and about 2° C. above Tₒₙₛₑₜ of the polymer,
between about 3° C. below Tₒₙₛₑₜ of the polymer and about 1° C. above Tₒₙₛₑₜ of the polymer,
about 0° C. to about 10° C. below Tₒₙₛₑₜ of the polymer,
about 0° C. to about 5° C. below Tₒₙₛₑₜ of the polymer,
about 1° C. to about 5° C. below Tₒₙₛₑₜ of the polymer,
about 1° C. to about 4° C. below Tₒₙₛₑₜ of the polymer, or
about 2° C. to about 3° C. below Tₒₙₛₑₜ of the polymer.

“Annealing” may also refer to thermal treatment of a crystalline or semi-crystalline polymer at a temperature that is greater than a temperature at which endothermic heat flow becomes observable prior to a solid-to-liquid phase transition in a DSC thermogram, and less than Tₘ of the polymer, defined as an endothermic peak in the DSC thermogram. The annealing temperature may be:
greater than a temperature at which endothermic heat flow becomes observable in the DSC thermogram, and
at or below a temperature which is less than Tₘ, and corresponds to 70%, 50%, 40%, 30%, or 20% of the maximum endothermic peak height in the DSC thermogram.
   Also, the annealing temperature may be greater than a temperature at which endothermic heat flow becomes observable in the DSC thermogram, and at or below Tₒₙₛₑₜ of the polymer.

Unless otherwise characterized, numerical values used herein should be understood in terms of significant figures. For example, “10” has two significant figures, and should be understood to mean greater than 9.5, and less than 10.49.

“Sintering,” as used in the present disclosure, refers to forming a solid mass of material by heating particulate material without melting the material. During sintering, diffusion of polymer chains across particle boundaries fuses the particles together and forms a solid article. Sintering may be carried out at a temperature between the onset temperature for polymer crystallization and Tₒₙₛₑₜ.

“Selective laser sintering”, or SLS, as used in the present disclosure, refers to an additive manufacturing technique that uses a laser as the power source to heat a powdered polymer material to the point of sintering. SLS aims the laser under computer control in a layer-by-layer manner at a layer of polymer powder in areas corresponding to a cross section of a 3D model, binding the polymer powder together to create a solid structure. After laser sintering of a first cross-sectional layer, additional powder is deposited on the sintered layer and a second layer is created by laser sintering of a second cross section of the model. This process is continued until a complete structure corresponding to the 3D model is produced.

Polymers which may be used in the process disclosed herein have a melting onset temperature, Tₒₙₛₑₜ, of between 50° C. and 170° C., with a melting point which is from 1° C. to 20° C. above Tₒₙₛₑₜ, from 2° C. to 15° C. above Tₒₙₛₑₜ, from 3° C. to 10° C. above Tₒₙₛₑₜ, or from 4° C. to 8° C. above Tₒₙₛₑₜ. The polymers are crystalline or semicrystalline. The process may also be applied to amorphous polymers, if the polymers have a defined melting point, and are crystallizable upon being subjected to annealing.

Suitable polymers include C4-C8 lactone polymers; low melting polyesters; polymers of olefins selected from the group consisting of ethylene, propylene, n-butene, iso-butene, and mixtures thereof; or a polyvinyl acetal. In particular, the process may be carried out with olefin polymers, such as ethylene homo- and copolymers, propylene homo- and copolymers, n-butene homo- and copolymers; trans-polybutadiene; biodegradable or bioresorbable polymers including poly(ethylene adipate), poly(lactic acid), poly(caprolactone), and polyvinyl butyrals.

In various embodiments, the polymer powder is a polyester obtained by polycondensation of a lactone selected from the group consisting of 3,6-dimethyl-1,4-dioxan-2,5-dione, trimethylene carbonate, an α-lactone, a β-lactone, a γ-lactone, a δ-lactone, a ε-lactone, and a mixture thereof; a hydroxy acid selected from the group consisting of an α-hydroxycarboxylic acid, a β-hydroxycarboxylic acid, a γ-hydroxycarboxylic acid, a δ-hydroxycarboxylic acid, and a mixture thereof, or a mixture of a lactone and a hydroxy acid. The polymer powder may a polyester obtained by polycondensation of at least one lactone selected from the group consisting of δ-valerolactone, ε-caprolactone, and a mixture thereof; and a comonomer selected from the group consisting of 3,6-dimethyl-1,4-dioxan-2,5-dione, trimethylene carbonate, lactic acid, glycolic acid, and a mixture thereof.

The polymer powder may be a homopolyester obtained by polycondensation of ε-caprolactone; or a copolyester obtained by polycondensation of a) ε-caprolactone and b) 3,6-dimethyl-1,4-dioxan-2,5-dione, lactic acid, glycolic acid, or a mixture thereof.

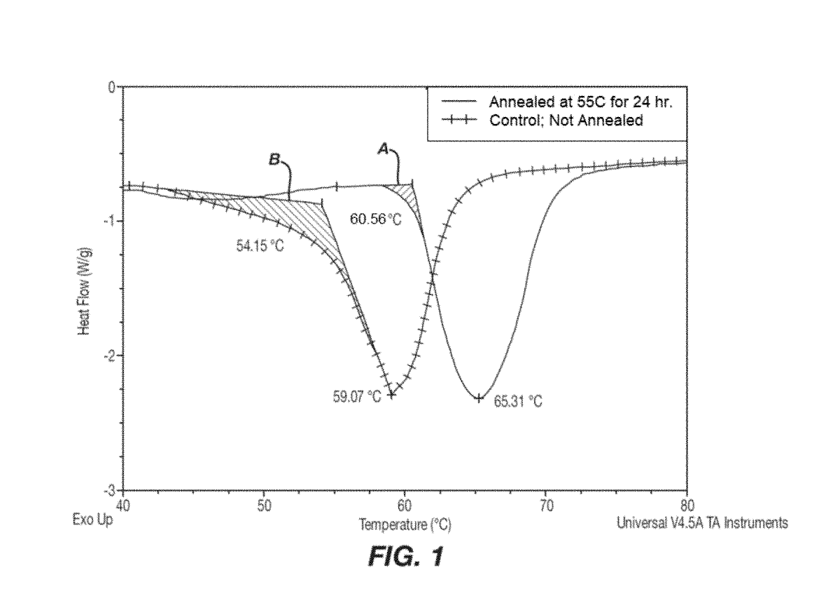

The polymers are annealed at a temperature that is either near Tₒₙₛₑₜ of the polymer, or about 5° C. below Tₒₙₛₑₜ to about Tₒₙₛₑₜ of the polymer, and greater than a temperature at which endothermic heat flow becomes observable prior to a solid-to-liquid phase transition. FIG. 1 shows a DSC thermogram of unannealed poly(caprolactone) powder (left hand trace) with a melting onset temperature, Tₒₙₛₑₜ, of 54.15° C. Prior to annealing, significant heat flow is observed prior to Tₒₙₛₑₜ (Shaded area B), indicating that softening of the polymer begins several degrees prior to Tₘ. Based on FIG. 1, poly(caprolactone) may be annealed at temperatures below 50° C., if desired. However, annealing at temperatures up to 5° C., up to 4° C., up to 3° C., up to 2° C., or within 1° C. of Tₒₙₛₑₜ may also be applied. Annealing may be carried out for the period of time required for the heat to work its way from the exterior into the bulk of the material. Annealing may be carried out in one step for between 2 hours and 48 hours, between 8 and 48 hours, between 2 and 24 hours, between 8 and 24 hours, between 12 and 30 hours, between 12 and 24 hours, or between 24 and 48 hours. Annealing may also be carried out in multiple steps of between 2 hours and 48 hours, between 2 and 24 hours, between 2 and 8 hours, between 8 and 24 hours, or between 2 and 12 hours. Given a properly designed heating method, annealing could be performed almost instantaneously.

Without being bound by any theory, it is believed that the annealing step increases the crystallinity of the polymer powder. Amorphous regions of the polymer become more crystalline. Also, should two or more polymorphs with similar melting points exist within the polymer matrix, thermal treatment during the annealing step causes the lower-melting, less stable, polymorph to undergo a phase transition into the higher melting polymorph. The result is a polymer powder of increased crystallinity, and a microstructure of increased uniformity. The increased crystallinity leads to both an increased melting point and an increased Tₒₙₛₑₜ. Increased uniformity in the microstructure may be observed from an increasingly symmetrical endothermic DSC curve on melting, and a sharper Tₒₙₛₑₜ. As seen in FIG. 1, the unannealed powder (left trace) has an asymmetric endothermic DSC peak on melting, with a gradual increase in endothermic heat flow followed by a sharp decrease in heat flow. After annealing (right trace), the powder has a symmetric endothermic DSC peak on melting.

The actual increase in Tₘ is dependent on the percentage change in polymer crystallinity upon annealing. A very highly crystalline polymer may be at or near its maximum Tₘ without annealing. A semicrystalline or crystallizable, but amorphous, polymer will have a higher degree of amorphous material in the polymer matrix, and will increase both Tₘ and crystallinity upon annealing. For example, consider two samples of a poly(caprolactone) homopolymer of equivalent molecular weight, where one sample has an initial Tₘ of 59° C. (corresponding to the left trace of FIG. 1) and the other has an initial Tₘ of 63° C. As shown in FIG. 1, poly(caprolactone) homopolymer with an initial Tₘ of 59° C. increases its melting point to 65° C. upon annealing at a temperature of 55° C. for 24 hours, for an increase in Tₘ of 6° C. Poly(caprolactone) homopolymer with an initial Tₘ of 63° C. will not exhibit an increase in Tₘ of 6° C. upon annealing at 55° C. for 24 hours, however. The increased initial Tₘ reflects increased initial crystallinity of the polymer. Since there is a point beyond which crystallinity of a polymer cannot readily increase, annealing a high crystallinity polymer will not produce the same change in Tₘ as annealing a low crystallinity polymer. If annealing poly(caprolactone) homopolymer with an initial Tₘ of 59° C. at of 55° C. for 24 hours increases its melting point by 6° C. to 65° C., annealing poly(caprolactone) homopolymer with an initial Tₘ of 63° C. at of 55° C. for 24 hours would also be expected to increase Tₘ to 65° C., with a change in melting point of 2° C. In short, annealing polymers of similar structure and similar molecular weights, but different initial melting points, under identical conditions will cause the polymer melting points to converge on a common Tₘ, not to undergo identical changes in Tₘ. Additionally, annealing such polymers of different initial melting points under identical conditions will cause the polymer melting onset temperatures to converge on a common Tₒₙₛₑₜ. Therefore, the annealing process allows preparation of a polymer powder of uniform thermal properties from polymer powders from different sources or batches.

Such polymer powders of similar structure and similar molecular weights, but different initial melting points, may be mixed to produce a mixed polymer powder, and annealed to prepare a polymer powder of uniform thermal properties. The step of mixing may be carried out before or after the annealing step. Prior to annealing, the polymer powders used in the mixture will have two dissimilar melting points Tₘ and two dissimilar melting onset temperatures Tₒₙₛₑₜ. After both mixing and annealing, the mixed polymer powder has will have a single uniform melting point Tₘ and a single uniform melting onset temperature Tₒₙₛₑₜ. The annealing step eliminates differences in thermal history arising from processing differences, and produces a single polymer with a uniform melting point and a uniform microstructure.

The final melting point achieved upon annealing may also a function of polymer molecular weight. For example, two samples of a poly(caprolactone) homopolymer of different molecular weight, but similar initial Tₘ may be annealed under the same conditions, where the high molecular weight sample would be expected to undergo a greater increase in Tₘ.

The annealed powders produced by the process of this invention are well suited for additive manufacture by SLS. Low-melting prior art powders for use in SLS are not annealed, and have unacceptably low melting onset temperatures. Upon scanning a laser over a powder bed, prior art powders sinter in areas corresponding to a cross section of a 3D model, as desired. However, near an edge of such an area, but outside the desired area, prior art powders may sinter due to heat from the laser and bind to the structure manufactured by SLS. Undesired sintering of this type may result in occlusion of pores in the final structure, and reduced void volume. Since pores for tissue ingrowth are needed in implantable medical devices, this severely limits the utility of bioresorbable polymers for preparation of medical devices by SLS. Annealing a polymer powder prior to SLS reduces undesired sintering beyond areas directly scanned by the laser, and offers reduced pore occlusion and increased void volume, as shown by the polycarprolactone device prepared from powder annealed at 52° C. for 24 hours.

### EXAMPLES

Determination of melting points Tₘ and melting onset temperatures Tₒₙₛₑₜ reported in the following examples involved differential scanning calorimetry (DSC). In each case, the temperature of the sample was ramped to 200° C. at a rate of 10° C./min to determine melting onset temperature Tₒₙₛₑₜ and Tₘ. The temperature of the sample was then ramped to −80° C. at a rate of 10° C./min to determine crystallization temperature.

### Example 1. Impact of Annealing on Thermal Properties on Poly(Caprolactone) with a Melting Point of 59.1° C.

Poly(caprolactone) powder with a particle size distribution of between about 6 microns and 200 microns was obtained. When particle diameter was plotted as a function of volume (%), the peak particle size was ˜60 microns. The poly(caprolactone) powder had a single melting point (Tₘ) of 59.1° C., as shown in the DSC (differential scanning calorimetry) thermogram of FIG. 1 (Control; curve at left). The melting onset temperature (Tₒₙₛₑₜ) was determined to be 54.15° C.

The poly(caprolactone) powder was then annealed at a temperature of 55° C. for 24 hours. After annealing, the poly(caprolactone) powder had Tₘ of 65.3° C., as shown in the DSC thermogram of FIG. 1 (55C 24HR; curve at right). Tₒₙₛₑₜ was determined to be 60.56° C. Thus, the annealing step increases both Tₘ and Tₒₙₛₑₜ by ˜6° C.

Further, the shape of the DSC thermogram changes because of the annealing step. After annealing, the DSC curve of poly(caprolactone) powder is highly symmetric, with little heat flow prior to the recorded melting onset temperature. Heat flow increases prior to Tₘ at about the same rate that heat flow decreases after Tₘ. Prior to annealing, the DSC curve is asymmetric. Heat flow increases gradually prior to Tₘ, and decreases more rapidly after Tₘ. This is significant, because it impacts the extent of heat flow prior to melting onset temperature Tₒₙₛₑₜ. As seen in FIG. 1, after annealing, very lithe heat flow is seen prior to Tₒₙₛₑₜ (Shaded area A). In the absence of an annealing step, substantially more heat flow is seen prior to Tₒₙₛₑₜ (Shaded area B), indicating that softening of the polymer may begin several degrees prior to the reported melting onset temperature Tₘ.

Thus, annealing a poly(caprolactone) powder at a temperature near the melting onset temperature (Tₒₙₛₑₜ) results in a polymer having improved thermal properties, with a significantly higher melting point and a more sharply defined Tₒₙₛₑₜ.

### Example 2. Impact of Annealing Temperature and Annealing Time on Poly(caprolactone) with a Melting Point of 59.1° C.

Poly(caprolactone) powder with a melting point (Tₘ) of 59.1° C. and a melting onset temperature (Tₒₙₛₑₜ) of 54.15° C. was used in a study of the impact of annealing time and annealing temperature on thermal properties of the polymer. A sample of the powder was not annealed, and was used as a control. The powder was tested by annealing samples of the powder at temperatures ranging from 50° C. to 55° C. At each temperature, the powder was annealed for several time periods, ranging from 2 hours to 48 hours. The results are presented in Table 1.

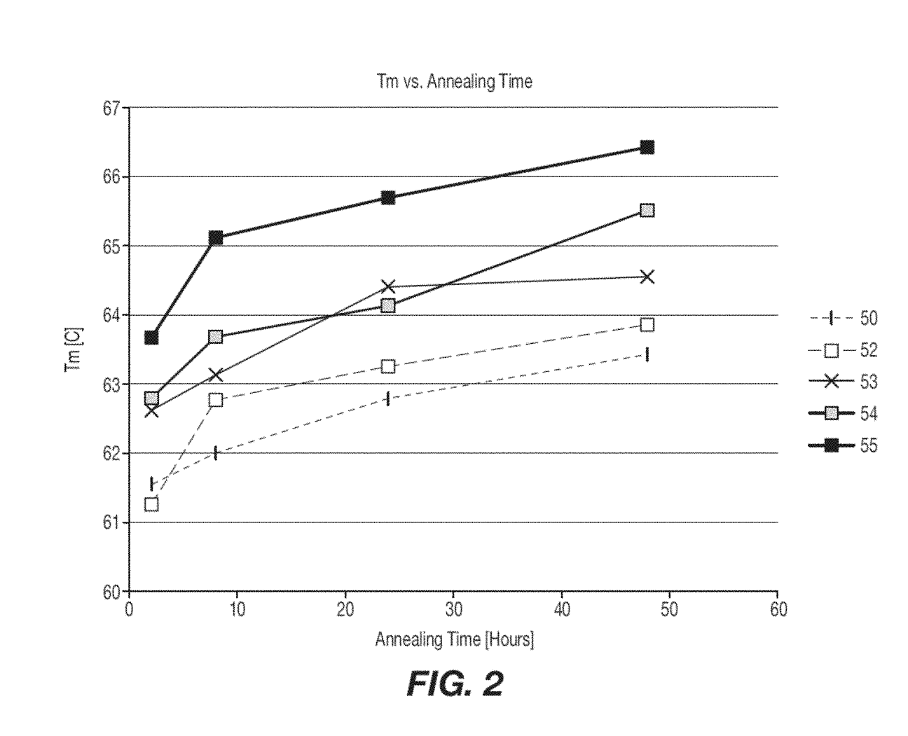

FIG. 2 shows the impact of annealing time on melting point Tₘ (° C.). At any given annealing temperature, Tₘ increases as annealing time decreases. At an annealing temperature of 50° C., Tₘ increases by ˜2.5° after two hours of annealing; by ˜3° after eight hours of annealing; by ˜3.7° after 24 hours of annealing; and by ˜4.4° after 48 hours of annealing. At an annealing temperature of 55° C., Tₘ increases by ˜4.6° after two hours of annealing; by ˜6° after eight hours of annealing; by ˜6.7° after 24 hours of annealing; and by ˜7.3° after 48 hours of annealing. As seen in FIG. 2, the annealing time required to produce a desired change in melting point of the polymer decreases as the annealing temperature increases. At an annealing temperature of between 54° C. and 55° C., annealing for between two and eight hours may be adequate to achieve a desired melting point, e.g., 63 to 64° C. However, at an annealing temperature of between 50° C. and 52° C., annealing for between 24 and 48 hours may be required to achieve the same result.

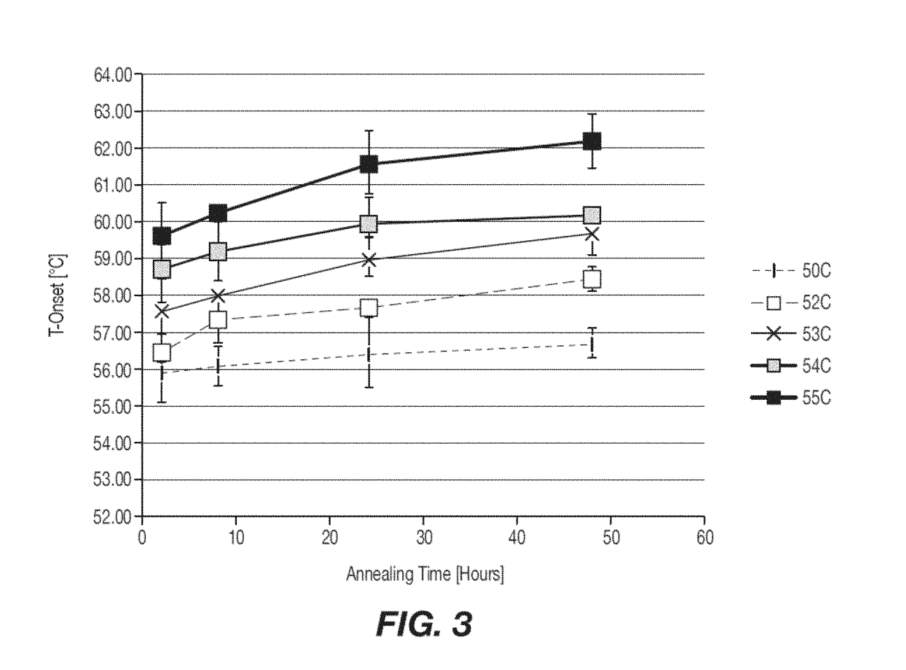

FIG. 3 shows the impact of annealing time on melting onset temperature Tₒₙₛₑₜ (° C.). As shown in FIG. 3, annealing for two hours at 50° C. increases Tₒₙₛₑₜ from 54.2° C. to 56° C. Longer periods of annealing may have a slightly greater effect on Tₒₙₛₑₜ, with 48 hours of annealing increasing Tₒₙₛₑₜ to 56.7° C. However, as demonstrated by the error bars in FIG. 3, it is unclear if the change in melting onset temperature Tₒₙₛₑₜ undergoes a significant change as the annealing period is extended from two hours to 48 hours.

Also, as shown in FIG. 3, annealing for two hours at 55° C. increases Tₒₙₛₑₜ from 54.2° C. to 59.7° C., an increase of about 5.5° C. Extending the annealing period further increases Tₒₙₛₑₜ, with 48 hours of annealing at 55° C. increasing Tₒₙₛₑₜ to 62.1° C., an increase of about 8° C. from Tₒₙₛₑₜ of the unannealed powder. Further, as demonstrated by the error bars in FIG. 3, the change in melting onset temperature Tₒₙₛₑₜ upon extending the annealing period from two hours to between 24 and 48 hours is significant. The data in FIG. 3 and in Table 1 shows that the greatest impact on Tₒₙₛₑₜ from annealing at a temperature of between 50° C. and 55° C. is observed within the first two hours of annealing.

TABLE 1
Change in Melting Point and Melting Onset Temperature as
a Function of Annealing Time and Annealing Temperature.

| Annealing | Annealing | | Melting |
|---|---|---|---|
| Time | Temp. | Tₘ | Onset Temp. |
| (hours) | (° C.) | (° C.) | (° C.) |
| 0 (Control) | N/A | 59.1 | 54.2 |
| 2 | 50 | 61.6 | 56.0 |
| 2 | 52 | 61.3 | 56.5 |
| 2 | 53 | 62.7 | 57.7 |
| 2 | 54 | 62.9 | 58.7 |
| 2 | 55 | 63.7 | 59.7 |
| 8 | 50 | 62.0 | 56.1 |
| 8 | 52 | 62.8 | 57.5 |
| 8 | 53 | 63.1 | 58.0 |
| 8 | 54 | 63.7 | 59.2 |
| 8 | 55 | 65.1 | 60.2 |
| 24 | 50 | 62.8 | 56.5 |
| 24 | 52 | 63.3 | 57.7 |
| 24 | 53 | 64.5 | 59.0 |
| 24 | 54 | 64.1 | 60.0 |
| 24 | 55 | 65.8 | 61.7 |
| 48 | 50 | 63.5 | 56.7 |
| 48 | 52 | 63.9 | 58.5 |
| 48 | 53 | 64.7 | 59.7 |
| 48 | 54 | 65.6 | 60.2 |
| 48 | 55 | 66.4 | 62.1 |

### Example 3. Impact of Annealing on Particle Size Distribution after Sintering on Poly(Caprolactone) with a Melting Point of 59.1° C.

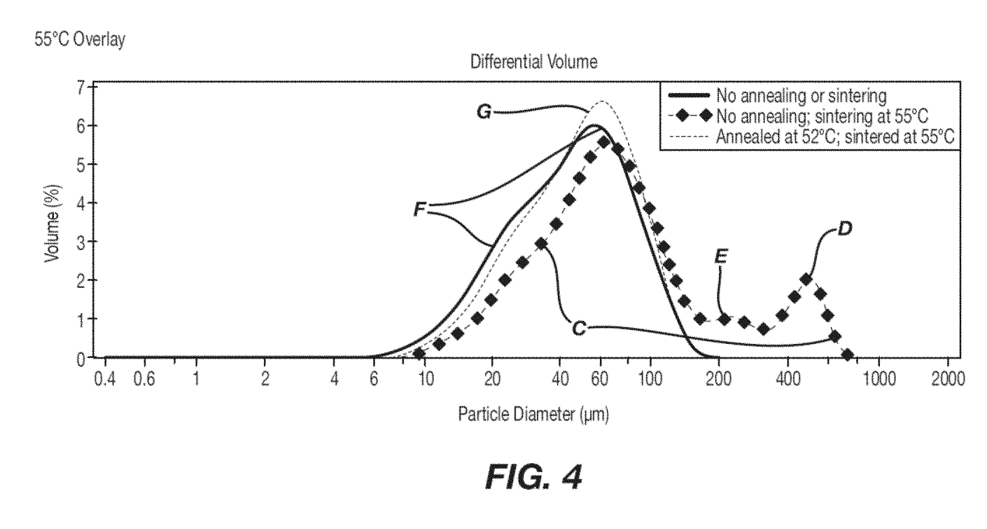

The initial particle size distribution of poly(caprolactone) powder with a melting point (Tₘ) of 59.1° C. and a melting onset temperature (Tₒₙₛₑₜ) of 54.15° C. was analyzed, as shown in FIG. 4. The particle size distribution was bimodal, with a peak at −50 microns, measured in term of volume % of particles having a defined particle diameter. The particle size distribution further showed that substantially all particles were larger than 6 microns and smaller than 200 microns. See trace F (solid line) in FIG. 4. An unresolved peak corresponding to smaller particles was also observed. The effect of sintering on particle size distribution, with and without annealing, was then studied.

The poly(caprolactone) powder was then sintered at 55° C. for 24 hours, without an annealing step. The particle size distribution changed dramatically after sintering. See trace C (line marked with diamonds markers) in FIG. 4. The particle size distribution expanded so that substantially all particles were larger than 6 microns and smaller than 800 microns. The particle size distribution also became multimodal, with new peaks D and E appearing at a particle size of between 200 and 600 microns. The size of the peak at −50 microns was reduced, and the peak particle size was shifted to ˜60 microns. The change in particle size distribution was attributed to polymer softening and particle agglomeration during sintering.

TABLE 2
Impact of Annealing on Poly(Caprolactone) Sintering.

| Annealing Conditions | | |
|---|---|---|
| (Temperature/Time) | Sintering Conditions | Results |
| None (Control) | 55° C./24 hrs | x |
| 50° C./24 hrs | 55° C./24 hrs | ∘ |
| 52° C./24 hrs | 55° C./24 hrs | ∘ |
| 54° C./24 hrs | 55° C./24 hrs | ∘ |
| 50° C./24 hrs | 58° C./24 hrs | x |
| 52° C./24 hrs | 58° C./24 hrs | x |
| 54° C./24 hrs | 58° C./24 hrs | x |

∘: No change in particle size distribution.
x: Large particle size peaks characteristic of sintering observed.

The poly(caprolactone) powder was then annealed prior to sintering. Three samples of the poly(caprolactone) powder were annealed for 24 hours, with one sample being annealed at 50° C., a second being annealed at 52° C., and a third being annealed at 54° C. The annealed samples were then sintered at 55° C. for 24 hours. The poly(caprolactone) powder was then sintered at 55° C. for 24 hours. As seen in FIG. 4, the particle size distribution was substantially unchanged upon sintering annealed poly(caprolactone) powder at 55° C., with all particles being larger than 6 microns and smaller than 200 microns. See trace G in FIG. 4, showing annealing at 52° C. (dashed line); particle size distribution after annealing at 50° C., 52° C., and 54° C. was essentially identical. After annealing poly(caprolactone) powder, particle agglomeration during sintering at 55° C. was not observed. However, when the experiment was repeated using poly(caprolactone) powder annealed for 24 hours at 50° C., at 52° C., and at 54° C., with a sintering temperature of 58° C., all poly(caprolactone) powder samples showed evidence of agglomeration from sintering.

Referring to Table 1, we see that poly(caprolactone) powder annealed for 24 hours at between 50° C. and 54° C. has a melting onset temperature of between 56.5° C. and 60° C. Agglomeration from sintering is not observed when annealing is carried out at 55° C., but is observed when sintering is carried out at 58° C. Thus, sintering cannot be carried out above the melting onset temperature of the annealed powder, without particle agglomeration. Sintering is preferably carried out at least 1.5° C., at least 2° C., or at least 3° C. below the melting onset temperature of the annealed powder.

### Example 4. Impact of Annealing on 3D Printed Articles

A three-dimensional cage with pores having a size of −500 microns was prepared by 3D printing, with a desired resolution of ±0.3 microns. The cage structure was designed using CAD software, and printed by layer-by-layer annealing of poly(caprolactone) powder. The poly(caprolactone) powder had an initial melting point (Tₘ) of 59.1° C., an initial melting onset temperature (Tₒₙₛₑₜ) of 54.15° C., and a mean particle size of 60 microns. A first powder layer was deposited at a layer thickness of 100 microns, and sintered by scanning a laser over an area corresponding to a cross section of the designed cage structure, where the area is defined by an edge. A second powder layer was deposited and sintered by scanning the laser over an area corresponding to a second cross section of the cage structure; this process is continued until the complete structure is formed.

The above process was first carried out using poly(caprolactone) powder without a step of annealing prior to 3D printing. The resulting cage had numerous 500 micron pores which were occluded by poly(caprolactone) powder, and did not achieve the desired printing resolution of ±0.3 microns. The powder layers used to form the cage underwent sintering in areas corresponding to defined cross sections of the designed cage structure, as intended. However, when the laser scanned portions of the layer along the edge of the defined cross sections, powder in areas beyond the edge of the scanned areas were heated and sintered, resulting in the undesired pore occlusions.

The 3D printing process was next carried out using poly(caprolactone) powder which had been annealed at 52° C. for 48 hours prior to 3D printing. The cage using annealed powder was designed with ˜500 micron pores, and did not exhibit occluded pores after printing. After annealing, powder adjacent to an edge defining a scanned portion of a defined cross section, but beyond the defined cross section, did not undergo sintering, resulting in fewer pore occlusions and increased void volumes in the finished article.

### Example 5. Impact of Annealing on Thermal Properties of a Polycaprolactone Homoploymer

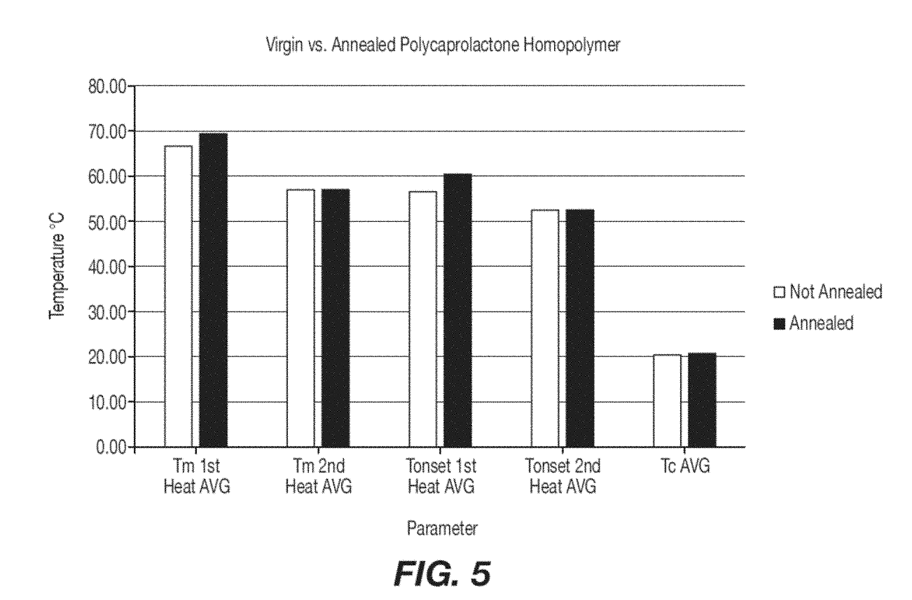

The impact of annealing on the thermal properties of a polycaprolactone (PCL) homopolymer with an inherent viscosity midpoint of 1.2 dl/g was tested. Initial melting points Tₘ₁ and melting onset temperatures Tₒₙₛₑₜ₁ were determined using DSC, with or without a prior annealing step. The temperature of each polycaprolactone homopolymer sample was ramped to 200° C. at a rate of 10° C./min to determine melting onset temperature Tₒₙₛₑₜ and Tₘ. The temperature of each sample was then ramped to −80° C. at a rate of 10° C./min to determine crystallization temperature T_{c}. Finally, the temperature of each sample was ramped to −80° C. at a rate of 10° C./min a second time, to determine a second melting onset temperature, Tₒₙₛₑₜ₂, and a second melting temperature, Tₘ₂, following melting and crystallization. All values are reported as the average of two samples, and are reported in Table 3 and FIG. 5. Annealing is carried out at 51.8° C. for 19 hours.

TABLE 3
Impact of Annealing on Poly(Caprolactone) Thermal Properties.

| | PCL (inherent | PCL (inherent | Change upon |
|---|---|---|---|
| | viscosity: 1.2 dl/g) | viscosity: 1.2 dl/g) | annealing |
| Parameter | (not annealed) | (annealed) | (° C.) |
| Tₘ₁ (° C.) | 66.73 | 69.32 | +2.59 |
| Tₒₙₛₑₜ₁ (° C.) | 56.77 | 60.52 | +3.75 |
| T_{c} (° C.) | 20.48 | 20.68 | +0.20 |
| Tₘ₂ (° C.) | 57.12 | 57.18 | +0.06 |
| Tₒₙₛₑₜ₂ (° C.) | 52.53 | 52.64 | +0.11 |

As shown in Table 3, in the absence of annealing, PCL homopolymer with an inherent viscosity of 1.2 dl/g has an initial melting point, Tₘ₁, of 66.73° C., with a melting onset temperature, Tₒₙₛₑₜ₁, of 56.77° C. After annealing at 51.8° C. for 19 hours, PCL homopolymer with an inherent viscosity of 1.2 dl/g has a Tₘ₁, of 69.32° C., with a Tₒₙₛₑₜ₁ of 60.52° C. Thus, annealing increases Tₘ₁ by 2.59° C., and increases Tₒₙₛₑₜ₁ by 3.75° C.

After melting, PCL homopolymer with an inherent viscosity of 1.2 dl/g has a crystallization temperature from the melt of ˜20.5° C., regardless of whether the PCL homopolymer was annealed prior to melting. Similarly, after melting and subsequent cooling and crystallization, the second melting onset temperature, Tₒₙₛₑₜ₂, and the second melting temperature, Tₘ₂, are unaffected by annealing prior to melting. Thus, annealing prior to melting changes the thermal properties of PCL homopolymer powder with an inherent viscosity of 1.2 dl/g. However, once the annealed powder has melted, its thermal properties are indistinguishable from those of PCL homopolymer powder which has never been annealed. Without being bound by any theory, it is believed that annealing changes the crystallinity of the polymer powder, without changing the molecular structure of the polymer.

### Example 6. Impact of Annealing on Thermal Properties on Poly(Caprolactone) with a Melting Point of 63° C.

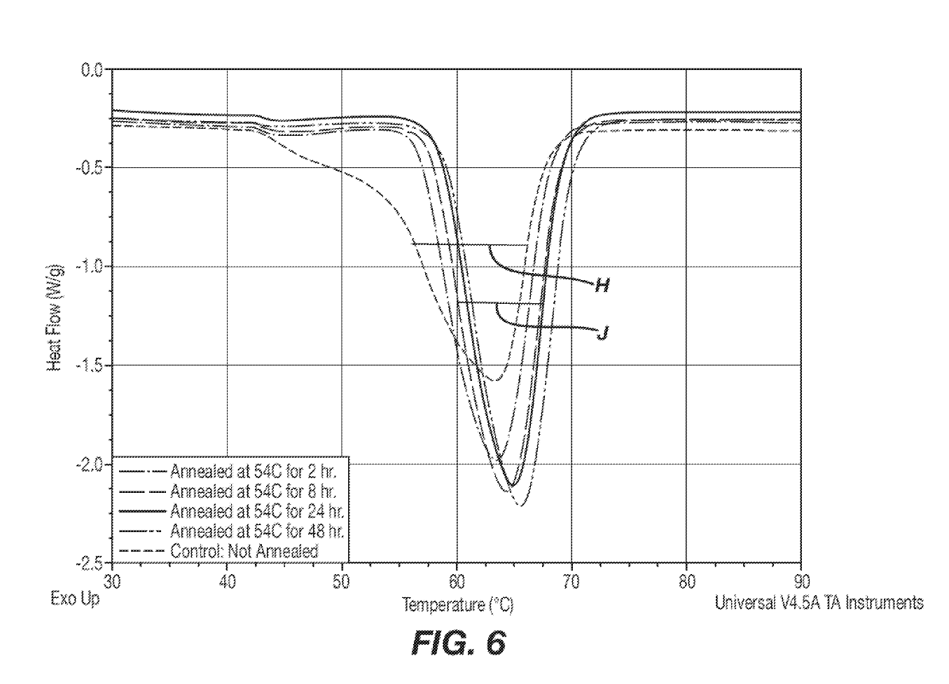

Commercial grade poly(caprolactone) powder was obtained. The commercial grade poly(caprolactone) powder had a single melting point (Tₘ) of 63° C., as shown in the DSC (differential scanning calorimetry) thermogram of FIG. 6 (Control; Not Annealed). The melting onset temperature (Tₒₙₛₑₜ) was determined to be 52.8° C. Thus, when compared to the poly(caprolactone) powder of Example 1 (Tₘ=59.1° C.; Tₒₙₛₑₜ=54.2° C.), the commercial grade poly(caprolactone) powder had a higher melting point, and a broader melting range.

The poly(caprolactone) powder was then annealed at a temperature of 54° C. for between 2 and 48 hours, as shown in the DSC thermogram of FIG. 6. After annealing for two hours, the commercial grade poly(caprolactone) powder had a Tₒₙₛₑₜ of 56.7° C., with little apparent change in melting point Tₘ. As annealing time increases, both Tₒₙₛₑₜ and Tₘ increase. After annealing for 48 hours at 54° C., the commercial grade poly(caprolactone) powder had a Tₒₙₛₑₜ of 58.8° C., with a melting point Tₘ of about 66° C. As seen in FIG. 6, annealing commercial grade poly(caprolactone) powder for as little as 2 hours increases melting onset temperature Tₒₙₛₑₜ, and narrows the melting range of the polymer. Annealing for longer periods, e.g., 24 to 48 hours, additionally increases the melting point Tₘ, as seen in FIG. 6.

Thus, annealing commercial grade poly(caprolactone) powder at a temperature near the melting onset temperature (Tₒₙₛₑₜ) results in a polymer having improved thermal properties, with a significantly narrower melting range and an increased Tₒₙₛₑₜ.

Further, annealing commercial grade poly(caprolactone) powder for 24 hours increases Tₘ to about 65° C., as compared to a Tₘ prior to annealing of about 63° C. By comparison, annealing the poly(caprolactone) powder of Example 1 for 24 hours increases Tₘ to about 65.3° C., as compared to a Tₘ prior to annealing of about 59.1° C. This provides evidence that annealing polymers of similar structure and similar molecular weights, but different initial melting points, under identical conditions will cause the polymer melting points to converge on a common Tₘ as each polymer becomes more highly crystalline during the annealing process.

Also, the results on commercial grade poly(caprolactone) show that annealing can be carried out at temperatures similar to the Tₒₙₛₑₜ of the unannealed polymer (annealing at 53° C., vs. Tₒₙₛₑₜ of 52.8° C.), or above Tₒₙₛₑₜ (annealing at 54° C. or 55° C., vs. Tₒₙₛₑₜ of 52.8° C.).

### Example 7. Impact of Annealing Temperature and Annealing Time on Poly(caprolactone) with a Melting Point of 63° C.

Commercial grade poly(caprolactone) powder with a melting point (Tₘ) of 63° C. and a melting onset temperature (Tₒₙₛₑₜ) of 52.8° C. was used in a study of the impact of annealing time and annealing temperature on thermal properties of the polymer. A sample of the powder was not annealed, and was used as a control. The powder was tested by annealing samples of the powder at temperatures ranging from 51° C. to 55° C. At each temperature, the powder was annealed for several time periods, ranging from 2 hours to 48 hours.

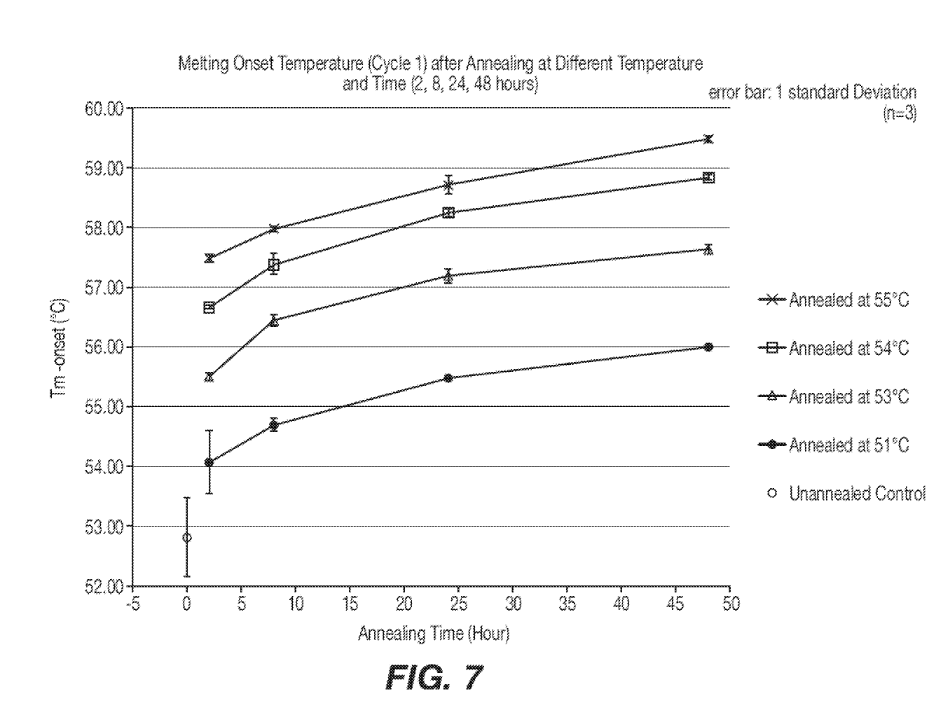

FIG. 7 shows the impact of annealing time on melting onset temperature Tₒₙₛₑₜ (° C.). As shown in FIG. 7, annealing for two hours at 51° C. increases Tₒₙₛₑₜ from 52.8° C. to 54° C. Longer periods of annealing may have a greater effect on Tₒₙₛₑₜ, with 48 hours of annealing at 51° C. increasing Tₒₙₛₑₜ to 56° C.

Also, as shown in FIG. 7, annealing for two hours at 55° C. increases Tₒₙₛₑₜ from 52.8° C. to 57.5° C., an increase of about 4.7° C. Extending the annealing period further increases Tₒₙₛₑₜ, with 48 hours of annealing at 55° C. increasing Tₒₙₛₑₜ to 59.5° C., an increase of about 6.7° C. from Tₒₙₛₑₜ of the unannealed powder.

Further, as demonstrated by the error bars in FIG. 7, the change in melting onset temperature Tₒₙₛₑₜ upon annealing for between two hours and 48 hours is significant, when compared to Tonset prior to annealing. The data in FIG. 7 shows that the greatest impact on Tₒₙₛₑₜ from annealing at a temperature of between 51° C. and 55° C. is observed within the first two hours of annealing.

### Example 8. Impact of Annealing on 3D Printed Articles Made from Poly(Caprolactone) Powder with Tₘ of 63°

A three-dimensional cage was prepared by 3D printing, with a desired resolution of ±0.3 microns. The cage structure was designed using CAD software, and printed by layer-by-layer annealing of poly(caprolactone) powder. The poly(caprolactone) powder had an initial melting point (Tₘ) of 63° C., an initial melting onset temperature (Tₒₙₛₑₜ) of 52.8° C. A first powder layer was deposited at a layer thickness of 100 microns, and sintered by scanning a laser over an area corresponding to a cross section of the designed cage structure, where the area is defined by an edge. A second powder layer was deposited and sintered by scanning the laser over an area corresponding to a second cross section of the cage structure; this process is continued until the complete structure is formed.

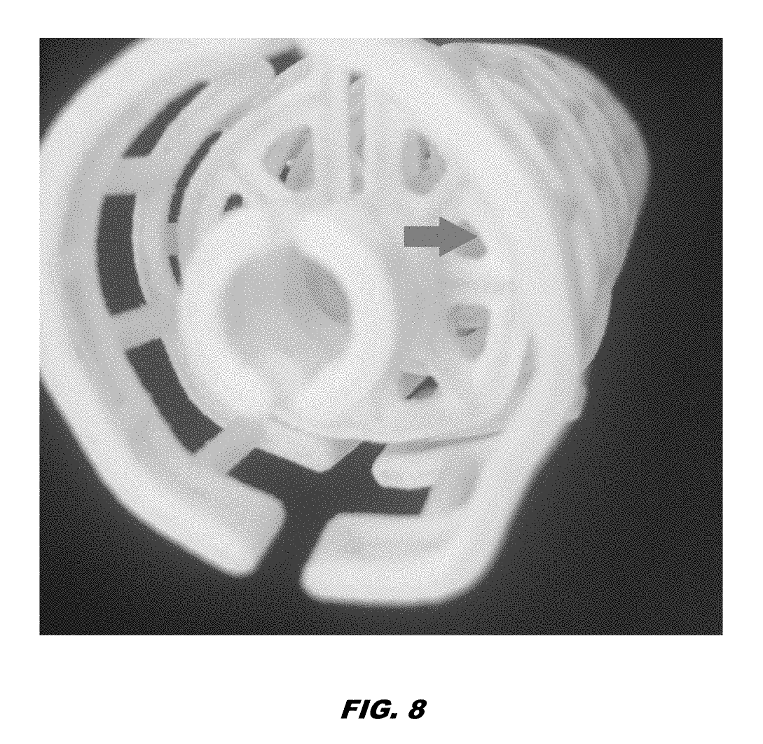

The above process was first carried out using poly(caprolactone) powder without a step of annealing prior to 3D printing. The resulting cage, shown in FIG. 8, did not achieve the desired printing resolution of ±0.3 microns. The powder layers used to form the cage underwent sintering in areas corresponding to defined cross sections of the designed cage structure, as intended. However, when the laser scanned portions of the layer along the edge of the defined cross sections, powder in areas beyond the edge of the scanned areas were heated and sintered, resulting in undesired occlusions in cage openings. As seen in FIG. 8, openings are defined by spokes radiating from a central hub (see arrow in FIG. 8); however, oversintering of the unannealed poly(caprolactone) powder results in partial occlusion of these openings.

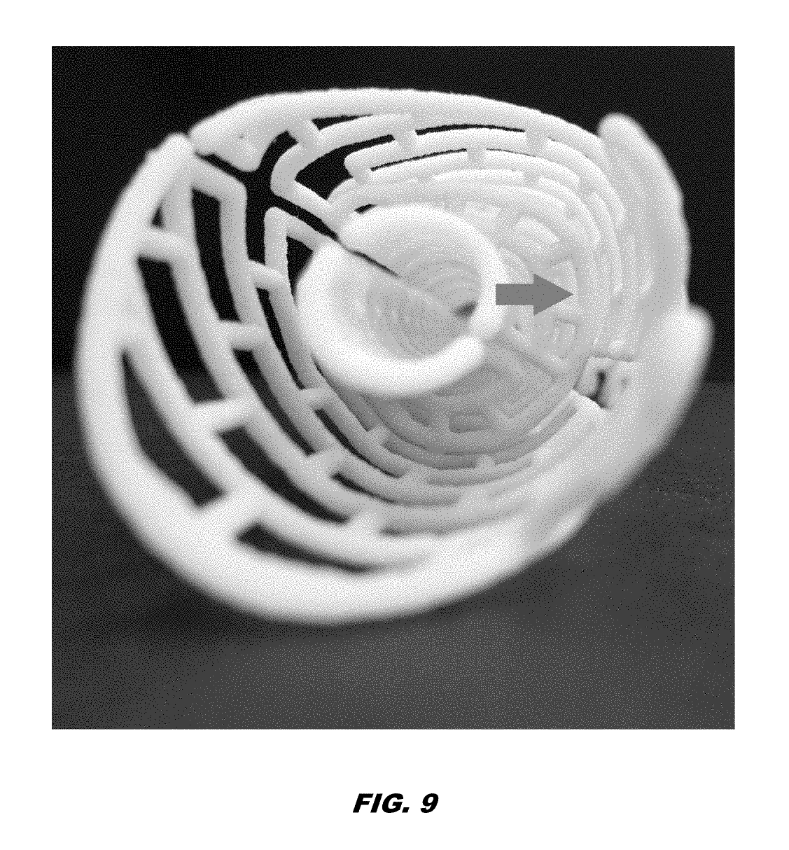

The 3D printing process was next carried out using poly(caprolactone) powder which had been annealed at 54° C. for 48 hours prior to 3D printing. The resulting cage, shown in FIG. 9, did not exhibit occluded pores after printing. As seen in FIG. 9, openings are defined by spokes radiating from a central hub. Oversintering of the annealed poly(caprolactone) powder does not occur. The resulting cage, when compared to the cage of FIG. 8, exhibits little or no occlusion of the openings defined by the radiating spokes (see arrow in FIG. 9). Compared to the cage of FIG. 8, the cage of FIG. 9 exhibits narrower spokes and larger, unoccluded openings between adjacent spokes.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Further, various elements from the various embodiments may be combined to form other embodiments that are within the spirit and scope of the invention. Accordingly, the foregoing disclosure, description, and figures are for illustrative purposes only and do not in any way limit the invention, which is defined only by the claims.

What is claimed is:

1. A method for producing a three-dimensional object by laser sintering, comprising:
annealing a polymer powder having a melting onset temperature of between 50° C. and 170° C. and a melting point for a period of between 5 minutes and 48 hours, said annealing being carried out at a temperature which is a) below said melting point, and b) from 5° C. above said melting onset temperature to 10° C. below said melting onset temperature;
applying a plurality of layers of the annealed polymer powder sequentially to a carrier; and
irradiating each layer of the annealed polymer powder with a laser beam in areas of the layer which correspond to the three-dimensional object to be produced, before applying a following layer, each of said areas having a defined edge;
wherein said irradiating sinters the annealed polymer powder in the corresponding areas, without sintering the annealed polymer powder in areas beyond said defined edges of the corresponding areas.

2. The method of claim 1, wherein said annealing is carried out at a temperature which is from 3° C. above said melting onset temperature to 10° C. below said melting onset temperature.

3. The method of claim 1, wherein said annealing is carried out at a temperature which is from 0° C. above said melting onset temperature to 5° C. below said melting onset temperature.

4. The method of claim 1, wherein the polymer powder is a polyester obtained by polycondensation of a C4-C8 lactone, a C3-C10 hydroxycarboxylic acid, or a mixture thereof; a polymer of an olefin selected from the group consisting of ethylene, propylene, n-butene, iso-butene, and a mixture thereof; or a polyvinyl acetal.

5. The method of claim 1, wherein the polymer powder is a polyester obtained by polycondensation of:
a lactone selected from the group consisting of 3,6-dimethyl-1,4-dioxan-2,5-dione, trimethylene carbonate, trimethylene carbonate, an α-lactone, a β-lactone, a γ-lactone, a δ-lactone, a ε-lactone, and a mixture thereof;
a hydroxy acid selected from the group consisting of an α-hydroxycarboxylic acid, a β-hydroxycarboxylic acid, a γ-hydroxycarboxylic acid, a δ-hydroxycarboxylic acid, and a mixture thereof, or
a mixture thereof.

6. The method of claim 1, wherein the polymer powder is a polyester obtained by polycondensation of:
a lactone selected from the group consisting of δ-valerolactone, ε-caprolactone, and a mixture thereof; and
a comonomer selected from the group consisting of 3,6-dimethyl-1,4-dioxan-2,5-dione, trimethylene carbonate, an α-hydroxycarboxylic acid, and a mixture thereof.

7. The method of claim 1, wherein the polymer powder is a homopolyester obtained by polycondensation of ε-caprolactone; or
a copolyester obtained by polycondensation of a) ε-caprolactone and b) 3,6-dimethyl-1,4-dioxan-2,5-dione, trimethylene carbonate, lactic acid, glycolic acid, or a mixture thereof.

8. The method of claim 4, wherein the polymer powder is poly(caprolactone); polyethylene; polypropylene; or a polyvinyl butyral.

9. The method of claim 8, wherein the polymer powder is poly(caprolactone).

10. The method of claim 9, wherein said poly(caprolactone) powder has an initial melting onset temperature of between 50° C. and 60° C. prior to annealing, and
wherein said annealing increases said initial melting onset temperature to a final melting onset temperature between about 2° C. and about 10° C. higher than said initial melting onset temperature.

11. The method of claim 10, wherein said annealing is carried out for a period of between 2 hours and 48 hours; and
wherein said final melting onset temperature is between about 3.5° C. and about 10° C. higher than said initial melting onset temperature.

12. The method of claim 11, wherein said annealing is carried out for a period of between 12 hours and 48 hours; and
wherein said final melting onset temperature is between about 5° C. and about 10° C. higher than said initial melting onset temperature.

13. The method of claim 10, wherein said annealed polycaprolactone powder has a defined particle size range; and
wherein said particle size range is unchanged upon sintering said annealed polycaprolactone powder at a sintering temperature of between about 5° C. below said initial melting onset temperature and about 5° C. above said initial melting onset temperature.

14. The method of claim 1, wherein said polymer powder comprises:
a first polymer powder having a first melting onset temperature T_{1,onset} of between 50° C. and 170° C. and a first melting point T_{1,m}, and
a second polymer powder having a melting onset temperature T_{2,onset} of between 50° C. and 170° C. and a second melting point T_{2,m}, where T_{1,m}>T_{2,m};
wherein said first and second polymer powders are made from the same polymer and have the same molecular weight; and
wherein said annealing causes T_{1,m} and T_{2,m} to each converge on a uniform melting point T_{3,m}.

15. The method of claim 14, further comprising:
mixing said first polymer powder and said second polymer powder to produce a mixed polymer powder, said mixing being carried out before or after said annealing;
wherein after said mixing and annealing, said mixed polymer powder has said uniform melting onset temperature T_{3,m}.

16. The method of claim 14, wherein:
said annealing causes T_{1,m} and T_{2,m} to each converge on said uniform melting point T_{3,m}; and
said annealing causes T_{1,onset} and T_{2,onset} to each converge on a uniform melting onset temperature T_{3,onset}.

17. The method of claim 1, wherein said polymer powder comprises:
a first polymer powder having a melting onset temperature T_{1,onset} of between >50° C. and 170° C., and
a second polymer powder having a melting onset temperature T_{2,onset} of between 50° C. and <170° C., where T_{1,onset}>T_{2,onset};
wherein said first and second polymer powders are made from the same polymer and have the same molecular weight; and
wherein said annealing causes T_{1,onset} and T_{2,onset} to each converge on a uniform melting onset temperature T_{3,onset}.

18. A method for producing a porous three-dimensional object by laser sintering, comprising:
annealing a polymer powder having a melting onset temperature of between 50° C. and 170° C. for a period of between 5 minutes and 48 hours, said annealing being carried out at a temperature which is:
a) below a melting point of the polymer powder; and
b) from 5° C. above said melting onset temperature to 10° C. below said melting onset temperature;
applying a plurality of layers of the annealed polymer powder sequentially to a carrier; and
constructing said porous three-dimensional object by irradiating each layer of the annealed polymer powder with a laser beam in areas of the layer which correspond to the three-dimensional object to be produced, before applying a following layer;
wherein said porous three-dimensional object has at least one of an increased void volume and reduced pore occlusions, compared to a comparative three-dimensional object produced from a portion of said polymer powder which has not been subjected to said annealing.

19. The method of claim 18, wherein said annealing is carried out for a period of between 2 hours and 48 hours.

20. The method of claim 18, wherein said annealing is carried out for a period of between 12 hours and 48 hours.
